(19) United States
(12) Patent Application Publication
(10) Pub. No.: US 2008/0175111 A1
(43) Pub. Date: Jul. 24, 2008

(54) Disc Device and Control Method for the Same

(76) Inventor: Kazuhide Hamada, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/858,933

(22) Filed: Sep. 21, 2007

(30) Foreign Application Priority Data
Jan. 19, 2007 (JP) 2007-009964

(51) Int. Cl. G11B 7/00

(52) U.S. Cl. 369/44.32

(57) ABSTRACT

Provided is an optical disc device and a control method for the same that are capable of shortening processing time for spherical aberration correction amount adjustment. The optical disc device includes: a spherical aberration corrector that corrects spherical aberration of a light beam on an optical disc; and a tracking controller that performs tracking control based on a tracking error signal. In the spherical aberration correction amount adjustment by the spherical aberration corrector, the spherical aberration corrector is arranged so that: it holds a tracking error signal immediately before an spherical aberration correction amount is changed, and performs the tracking control based on the held tracking error signal while the spherical aberration corrector is changing the spherical aberration correction amount; or it moves a light beam scanning position on the optical disc to a predetermined track while the spherical aberration corrector is changing the spherical aberration correction amount.

### CROSS-REFERENCES TO RELATED APPLICATIONS

This application relates to and claims priority from Japanese Patent Application No. 2007-9964, filed on Jan. 19, 2007, the entire disclosure of which is incorporated herein by reference.

### BACKGROUND

1. Field of the Invention

The invention relates generally to a disc device and a control method for the same and is suited for use in an optical disc device.

2. Description of Related Art

As a method for increasing the recording density of an optical disc, a method for reducing the size of a light beam spot on the optical disc has been employed. In this method, the size of the light beam spot can be reduced by shortening the wavelength of the light beam and using an objective lens with a high numerical aperture.

For example, a Blu-ray Disc (BD), for which a light beam with a wavelength of 405 (nm) and an objective lens with a numerical aperture of 0.85 are used, realizes no less than five times as large a recording capacity as a DVD, for which a light beam with a wavelength of 650 (nm) and an objective lens with a numerical aperture of 0.6 are used.

However, spherical aberration, which is proportional to the fourth power of the numerical aperture of an objective lens in relation to the thickness of a protective film on an optical disc, is generated in a light beam. Accordingly, the amount of spherical aberration variation caused by the thickness variation in a protective film on a disc is negligible in DVDs, but is measurable in Blu-ray discs.

In a conventional optical disc device for Blu-ray discs, spherical aberration of a light beam is corrected by a spherical aberration correction mechanism that has a predetermined configuration and is disposed in the optical path of the light beam in an optical pickup. As the spherical aberration correction mechanism, a configuration has been proposed where two lenses are disposed on the optical axis of a light beam and spherical aberration for correction is generated in this light beam using these two lenses (see JP2005-196947 A).

### SUMMARY

The above conventional spherical aberration correction mechanism using the two lenses is arranged so that one of the two lenses for spherical aberration correction serves as a fixed lens while the other serves as a movable lens, and by moving the movable lens in the optical axis direction of the light beam to change the distance between the two lenses, a correction amount for the spherical aberration correction using theses two lenses (hereinafter referred to as a spherical aberration correction amount) can be adjusted.

In an optical disc device equipped with the spherical aberration correction mechanism having the above arrangement, every time a new optical disc is mounted, the distance between the two lenses is adjusted so as to obtain an optimal spherical aberration correction amount for that disc.

Such an adjustment for the spherical aberration correction amount is performed by moving the movable lens little by little to sequentially change the distance between the two lenses, reproducing spherical aberration correction data that has been recorded in advance to a predetermined position of the optical disc, checking the quality of the reproduced spherical aberration correction data and determining the distance between the two lenses so that the above quality becomes the highest.

However, in the adjustment for the spherical aberration correction amount, when the movable lens is moved, a minute vibration in a direction perpendicular to the optical axis direction of the light beam is generated in the movable lens, and this vibration may displace a light beam spot on an information surface of a Blu-ray disc in the radial direction of the Blu-ray disc. This displacement of the light beam spot adversely affects a tracking error signal, and even causes track jump in the worst case.

In order to solve the above problem, a method has been proposed in JP2005-196947A, where tracking control is kept off during the adjustment for the spherical aberration correction amount (i.e., while the movable lens is being moved in the optical axis direction of the light beam).

However, in this method, since off-track occurs while the tracking control is off, it takes a certain amount of time to turn on the tracking control again after the spherical aberration correction is complete and move the light beam spot to a track of the optical disc.

However, since the adjustment for the spherical aberration correction amount is performed by moving the movable lens a plural number of times as described above, the generation of such an unwanted time every time the movable lens is moved will increase the entire processing time for the spherical aberration correction amount adjustment.

In the light of the problems above, it is an object of this invention to provide an optical disc device and a control method for the same that are capable of shortening the processing time required for a spherical aberration correction amount adjustment.

In order to achieve the above object, provided according to an aspect of this invention is an optical disc device that reads/writes data from/to an optical disc by projecting a light beam onto the optical disc, the optical disc device including: a spherical aberration corrector that corrects spherical aberration of the light beam on the optical disc; a tracking error signal generator that generates a tracking error signal with a signal level according to an off-track amount of the light beam on the optical disc based on a reflection light of the light beam reflected by the optical disc; a tracking controller that performs tracking control based on the tracking error signal, in which during an adjustment for a spherical aberration correction amount performed by the spherical aberration corrector, the tracking controller holds the tracking error signal immediately before the spherical aberration corrector changes the spherical aberration correction amount and performs the tracking control based on the held tracking error signal while the spherical aberration corrector is changing the spherical aberration correction amount.

Provided according to another aspect of this invention is a control method for an optical disc device that reads/writes data from/to an optical disc by projecting a light beam onto the optical disc, the method including: a first step of, when a spherical aberration correction amount for correcting spherical aberration of the light beam on the optical disc is adjusted by a spherical aberration corrector, holding a tracking error signal immediately before the spherical aberration correction amount is changed by the spherical aberration corrector; and a second step of, while the spherical aberration correction amount is being changed by the spherical aberration corrector, performing a tracking control based on the held tracking error signal.

Provided according to another aspect of this invention is an optical disc device that reads/writes data from/to an optical disc by projecting a light beam onto the optical disc, the device including: a spherical aberration corrector that corrects spherical aberration of the light beam on the optical disc; a tracking error signal generator that generates a tracking error signal with a signal level according to an off-track amount of the light beam on the optical disc based on a reflection light of the light beam reflected by the optical disc; a tracking controller that performs tracking control based on the tracking error signal, in which during an adjustment for a spherical aberration correction amount performed by the spherical aberration corrector, the tracking controller moves a scanning position of the light beam on the optical disc to a predetermined track while the spherical aberration corrector is changing the spherical aberration correction amount.

Provided according to another aspect of this invention is a control method for an optical disc device that reads/writes data from/to an optical disc by projecting a light beam onto the optical disc, the method including: moving, when a spherical aberration corrector that corrects spherical aberration for a light beam on the optical disc adjusts a spherical aberration correction amount, a scanning position of the light beam on the optical disc to a predetermined track while the spherical aberration corrector is changing the spherical aberration correction amount.

According to this invention, even if a disturbance is generated in the tracking error signal when the spherical aberration corrector changes the spherical aberration correction amount during the adjustment for the spherical aberration correction amount by the spherical aberration corrector, the disturbance will not affect the tracking control. Accordingly, the tracking control can be securely prevented from being disturbed every time the spherical aberration corrector changes the spherical aberration correction amount, thereby realizing an optical disc device and control method for the same capable of shortening the processing time of the spherical aberration correction amount adjustment.

Other aspects and advantages of the invention will be apparent from the following description and the appended claims.

### BRIEF DESCRIPTION OF THE DRAWINGS

FIG. 1 is a block diagram showing the configurations of optical disc devices according to a first embodiment and a second embodiment.

FIG. 2 is a schematic diagram showing the configuration of a spherical aberration corrector.

FIG. 3 is a block diagram showing the configuration of a digital signal processor in relation to spherical aberration correction processing according to the above first embodiment.

FIG. 4 is a flowchart showing a processing sequence in adjustment processing.

FIG. 5 is a flowchart showing a processing sequence in a spherical aberration correction amount adjustment according to the above first embodiment.

FIG. 6 shows a characteristic curve for explaining the spherical aberration correction processing.

FIG. 7 shows waveforms each showing the waveform of a tracking error signal and a tracking control signal.

FIG. 8 is a block diagram showing the configuration of a digital signal processor used in a spherical aberration correction processing according to the above second embodiment.

FIG. 9 is a flowchart showing a processing sequence in a spherical aberration correction amount adjustment according to the above second embodiment.

### DETAILED DESCRIPTION OF PREFERRED EMBODIMENTS

An embodiment of this invention will be described in detail below with reference to the attached drawings.

### (1) First Embodiment

(1-1) Configuration of Optical Disc Device in First Embodiment

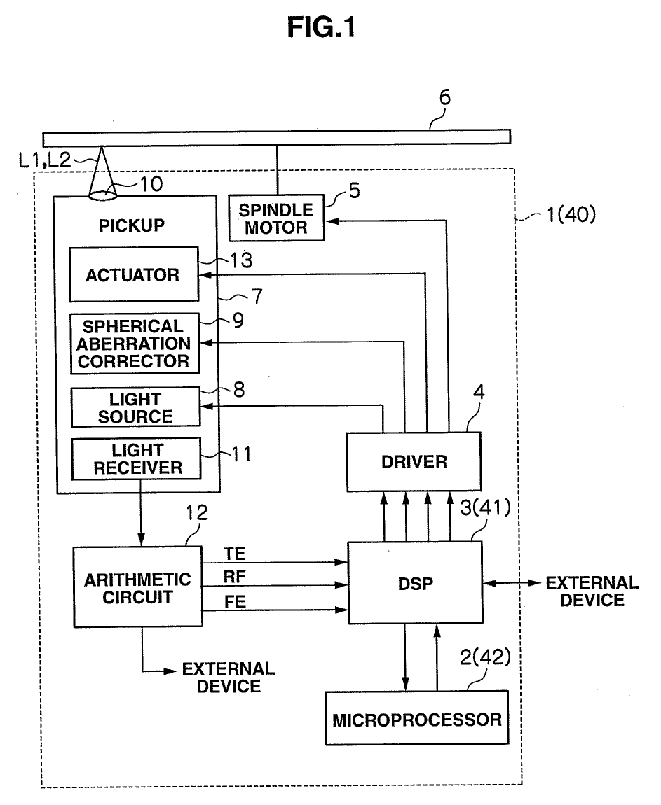

The reference numeral 1 in FIG. 1 represents the entire optical disc device according a first embodiment of this invention. The optical disc device 1 handles optical discs that require spherical aberration correction (e.g., Blu-ray disc), and the optical disc device 1 can write data on or reproduce data from those optical discs in accordance with requests from external devices.

During recording mode in the optical disc device 1, a spindle control signal output from a digital signal processor (DSP) 3 is supplied to a driver 4 under the control of a microprocessor 2. The driver 4 drives a spindle motor 5 based on this spindle control signal to rotate an optical disc 6 loaded in a predetermined state by a rotational condition according to a recording method for this optical disc 6 (e.g., a CLV (Constant Linear Velocity) method or a CAV (Constant Angular Velocity) method).

The digital signal processor 3 performs predetermined signal processing such as modulation processing for recording target data, which has been transmitted from an external device or similar, and transmits the resulting light source control signal to the driver 4. Based on this light control signal, the driver 4 drives a light source 8, which may be a lased diode or similar, in an optical pickup 7 to blink. Accordingly, a light beam L1 that blinks with a pattern according to the recording target data is projected from the light source 8, and the light beam L1 is then corrected for spherical aberration by a spherical aberration corrector 9 and focused on an information surface of the optical disc 6 via an objective lens 10. As a result, the recording target data is recorded on the optical disc 6.

Reflection light L2 of this light beam L1, which has been reflected by the information surface of the optical disc 6, is focused on a light receiver 11 after being sequentially transmitted through the objective lens 10 and the spherical aberration corrector 9. The light receiver 11 may be a quadrant photodetector or similar, and performs a photoelectric conversion of the incident reflection light L2 and transmits the resulting RF (Radio Frequency) signal to an arithmetic circuit 12.

The arithmetic circuit 12 generates, based on the supplied RF signal, a tracking error signal TE having a signal level according to the amount of displacement (off-track amount) of a spot formed by the light beam L from a track on the information surface of the optical disc 6 and a focus error signal FE having a signal level according to the defocus amount of the light beam L1 on the information surface of the optical disc 6. The arithmetic circuit 12 transmits these signals to the digital signal processor 3.

The digital signal processor 3 generates a tracking control signal based on the supplied tracking error signal TE and transmits the tracking control signal to the driver 4. The driver 4 also generates a first actuator driving signal based on the tracking control signal, and transmits the first actuator driving signal to a biaxial actuator 13 that holds the objective lens 10 in the optical pickup 7. As a result, the biaxial actuator 13 is driven based on the first actuator driving signal and the tilt of the object lens 10 is adjusted so that the light beam L1 spot scans tracks on the information surface of the optical disc 6.

The digital signal processor 3 generates a focus control signal based on the supplied focus error signal and transmits the focus control signal to the driver 4. The driver 4 also generates a second actuator driving signal based on the focus control signal, and transmits the second actuator driving signal to the biaxial actuator 13. As a result, the biaxial actuator 13 is driven based on the second actuator driving signal, and the position of the optical lens 10 in a direction perpendicular to the optical disc 6 is adjusted so that the light beam L1 is focused on the information surface of the optical disc 6.

During reproduction mode, the digital signal processor 3 supplies a spindle control signal to the driver 4 under the control of the microprocessor 2. The driver 4 drives the spindle motor 5 based on the spindle control signal to rotate the optical disc 6 loaded in a predetermined state by a rotational condition according to a recording method for this optical disc 6.

The digital signal processor 3 transmits a light source control signal having a certain signal level to the driver 4 under the control of the microprocessor 2. The driver 4 then drives the light source 8 in the optical pickup 7 to blink based on the light source control signal. As a result, a light beam L1 having a predetermined power is projected from the light source 8 and the light beam L1 is then corrected for spherical aberration by the spherical aberration corrector 9 and focused on the information surface of the optical disc 6 via the objective lens 10.

Reflection light L2 of the light beam L1 that is reflected by the information surface of the optical disc 6 is focused on the light receiver 11 after being sequentially transmitted through the objective lens 10 and the spherical aberration corrector 9. The light receiver 11 performs photoelectric conversion of the incident reflection light L2 and transmits the resulting RF signal to the digital signal processor 3 via the arithmetic circuit 12. The digital signal processor 3 generates reproduction data having an original data format based on the supplied RF signal and transmits this reproduction data to an external device.

The arithmetic circuit 12 generates the above-described tracking error signal TE and focus error signal FE based on the supplied RF signal and transmits these signals to the digital signal processor 3. The digital signal processor 3 generates the above-described tracking control signal and focus control signal based on the supplied tracking error signal TE and focus error signal FE and transmits these generated signals to the driver 4. Accordingly, the tracking control and the focus control are performed based on the tracking control signal and focus control signal, like in the recording mode.

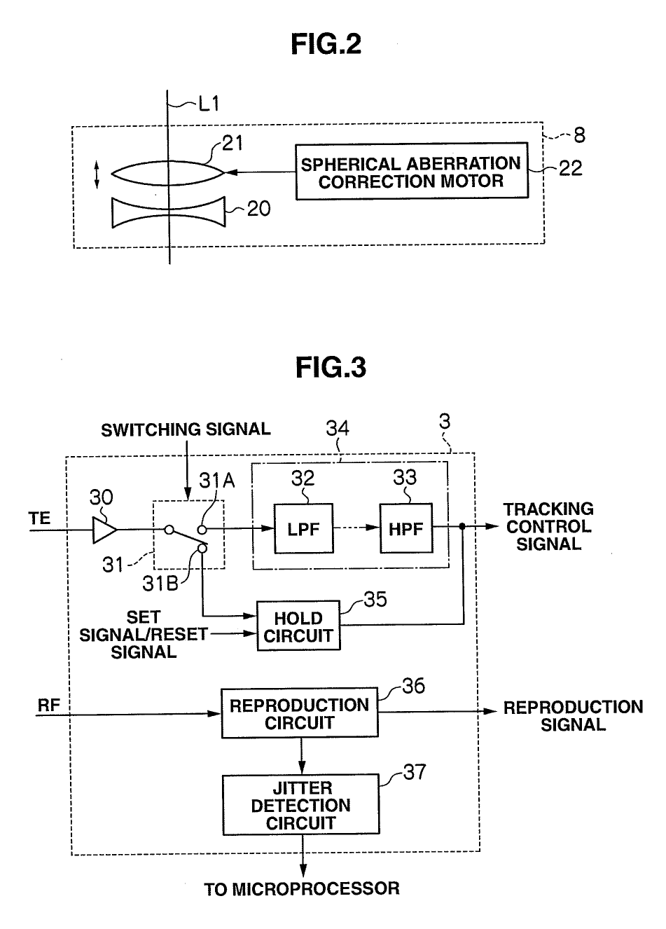

FIG. 2 shows in detail the configuration of the spherical aberration corrector 9. As is clear from FIG. 2, the spherical aberration corrector 9 is an expander having, for example, two lenses—a concave lens 20 and a convex lens 21.

The concave lens 20 and the convex lens 21 are disposed in the optical axis direction of the light beam L1, and arranged so that, for example, the convex lens 21 serving as a movable lens is moved in the optical axis direction of the light beam L1 by a stepping motor (hereinafter referred to as a spherical aberration correction motor) 22 relative to the concave lens 20 serving as a fixed lens.

With such an arrangement, the spherical aberration corrector 9 drives the spherical aberration correction motor 22 and changes the distance between the concave lens 20 and the convex lens 21 to change the degree of divergence of the light beam L1, thereby changing the spherical aberration amount of the spot on the information surface of the optical disc 6.

FIG. 3 shows the configuration of the digital signal processor 3 in relation to the generation of the tracking control signal. As is clear from FIG. 3, the digital signal processor 3 includes, in order to generate the tracking control signal, an amplifier 30, a switching circuit 31 and a filter group 34 connected to a first switch end 31A of the switch circuit 31, the filter group 34 having a plurality of filters such as a low pass filter 32 and a high pass filter 33.

The digital signal processor 3 inputs the tracking error signal TE supplied by the arithmetic circuit 12 to the filter group 34 through the amplifier 30 and the switching circuit 31, extracts a signal component having a predetermined frequency band with the filter group 34 and transmits the extracted signal component to the driver 4 as the tracking control signal.

A hold circuit 35 including, for instance, a sample hold circuit and a low pass filter is connected to a second switch end 31B of the switching circuit 31. The hold circuit 35 holds the signal level of an input signal when a set signal is supplied by the microprocessor 2 and outputs a signal with this signal level until a reset signal is supplied.

With the above arrangement, by supplying the set signal to the hold circuit 35 after switching the switch end of the switching circuit 31 from the initially-set first switch end 31A to the second switch end 31B, the digital signal processor 3 can hold the tracking error signal TE at this time and output a tracking control signal with a constant level based on the held tracking error signal TE. Then, by switching the switch end of the switching circuit 31 back to the first switch end 31A, the digital signal processor 3 can again output the tracking control signal with its signal level dynamically varying based on the tracking error signal TE.

In addition, the digital signal processor 3 includes: a reproduction circuit 36 that performs reproduction processing for the RF signal supplied by the arithmetic circuit 12 during the reproduction mode and transmits the resulting reproduction signal to the external device; and a jitter detection circuit 37 that detects a jitter amount representing a jitter level in the reproduction signal supplied by the reproduction circuit 36. The jitter detection circuit 37 transmits the detected jitter amount to the microprocessor 2 as a jitter detection signal. As a result, the microprocessor 2 can recognize the quality of the reproduction signal based on this jitter detection signal.

(1-2) Spherical Aberration Correction Method in Optical Disc Device

Next, a spherical aberration correction method employed in the above optical disc device 1 will be described.

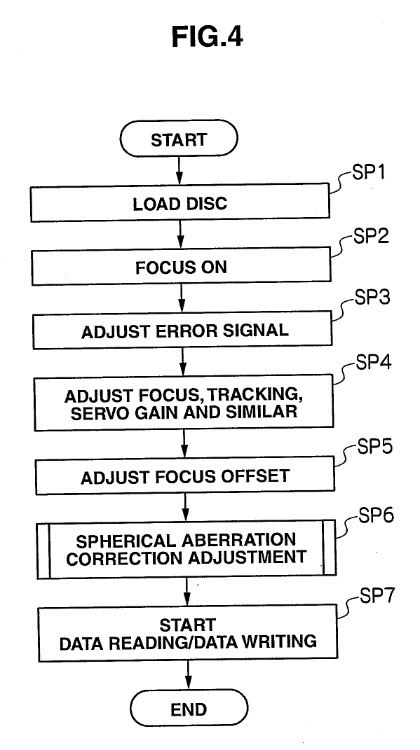

FIG. 4 shows a processing sequence in adjustment processing performed when an optical disc 6 is mounted in the optical disc device 1. When an optical disc 6 is mounted in the optical disc device 1, the optical disc 6 is first loaded (SP1). Then the light source 8 in the optical pickup 7 is driven and the light beam L1 having a predetermined power is projected onto the optical disc 6, and at the same time, the focus control for the light beam L1 is started (SP2).

Next, in the optical disc device 1, the focus control is performed so that the amplitude of a focus error signal is kept within a predetermined level (SP3), and then various gains for the focus control and the tracking control are adjusted so that the most stable control characteristic can be obtained (SP4) Then a focus offset is adjusted so that the light beam L1 projected from the optical pickup 7 is focused on a position slightly offset from a correct focus position on the information surface of the optical disc 6 (SP5), a spherical aberration correction amount is adjusted (SP6), and data writing or data reading is started (SP7).

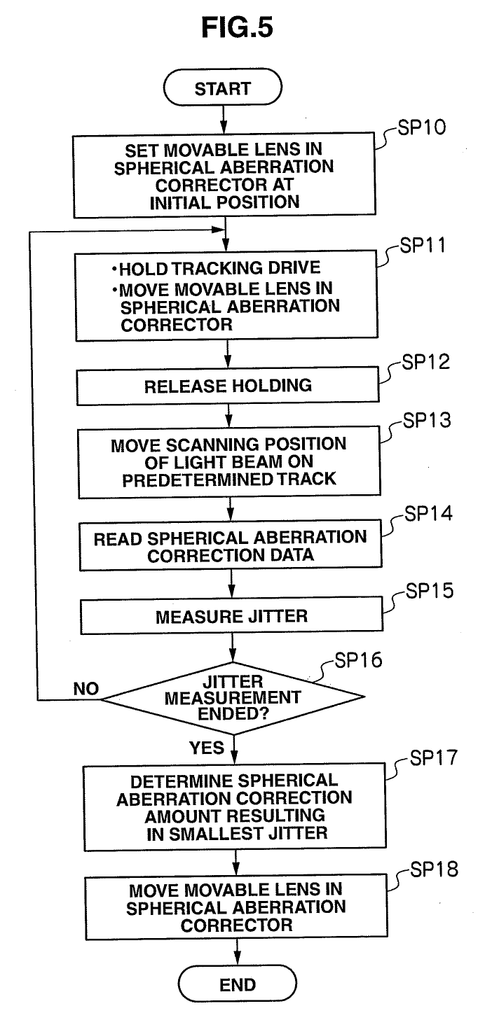

FIG. 5 shows in detail how the microprocessor 2 performs the adjustment for the spherical aberration correction amount in step SP6 of the above-described adjustment processing. The spherical aberration correction amount adjustment is performed by moving the convex lens 21 (movable lens) (FIG. 2) in the spherical aberration corrector 9 little by little in a direction away from the concave lens 20 (fixed lens) (FIG. 2) to read a spherical aberration correction signal that has been recorded in advance at a predetermined position inside the optical disc 6, detecting the spherical aberration correction amount where the jitter in the reproduction signal becomes smallest, and positioning the convex lens 21 at that position.

Specifically, when the process proceeds to step SP6 in the above adjustment processing, the microprocessor 2 starts the spherical aberration correction amount adjustment shown in FIG. 5, where the microprocessor 2 suitably drives, via the digital signal processor 3 and the driver 4, the spherical aberration correction motor in the above-described spherical aberration corrector 9 based on a control signal stored in an internal memory (not shown) in order to position the convex lens 21 at an initial position—the position closest to the concave lens 20 (SP10).

Next, the microprocessor 2 switches the switch end of the switching circuit 31 in the digital signal processor 3 from the first switch end 31A to the second switch end 31B, and supplies the set signal to the hold circuit 35 to hold the tracking error signal at this time (SP11). In this state, as shown in section (B) in FIG. 7, the tracking control signal with a constant signal level is output from the digital signal processor 3, and the tracking control is performed based on this tracking control signal.

At the same time, the microprocessor 2 drives, via the digital signal processor 3 and the driver 4, the spherical aberration correction motor 22 (FIG. 2) in the above-described spherical aberration corrector 9 provided in the optical pickup 7 by one pulse (SP11). Accordingly, the convex lens 21 (movable lens) in the spherical aberration corrector 9 is moved away from the concave lens 20 (fixed lens) by a predetermined distance in the optical axis direction of the light beam L1.

The microprocessor 2 then switches the switch end of the switching circuit 31 in the digital signal processor 3 from the second switch end 31B to the first switch end 31A and supplies the reset signal to the hold circuit 35, thereby releasing the hold state of the tracking error signal held by the digital signal processor 3 (SP12). Accordingly, the tracking control based on the tracking error signal with its signal level dynamically varying is restarted.

Next, the microprocessor 2 drives, via the digital signal processor 3 and the driver 4, the biaxial actuator 13 in the optical pickup 7 to move the scanning position of the light beam L1 on the optical disc 6 to a track on which the spherical aberration correction data has been recorded (SP13) and to read this spherical aberration correction data (SP14). The microprocessor 2 measures a jitter amount based on the jitter detection signal supplied from the digital signal processor 3 during this step (i.e., the quality of the reproduced spherical aberration correction data is verified) (SP15).

The microprocessor 2 judges whether or not the jitter measurement has been performed a predetermined number of times (SP16). When the judgment result is negative in step SP16, the microprocessor 2 returns to step SP11 and repeats the same processing until a positive judgment result is obtained in step SP16 (from step SP11 to step SP16, and back to step SP11).

When the jitter measurement has been performed the predetermined number of times and the positive judgment result is obtained in step SP16, the microprocessor 2 determines the spherical aberration correction amount where the jitter becomes smallest (i.e., where the quality of the reproduced spherical aberration correction data becomes highest) based on the results from the jitter measurement (SP17).

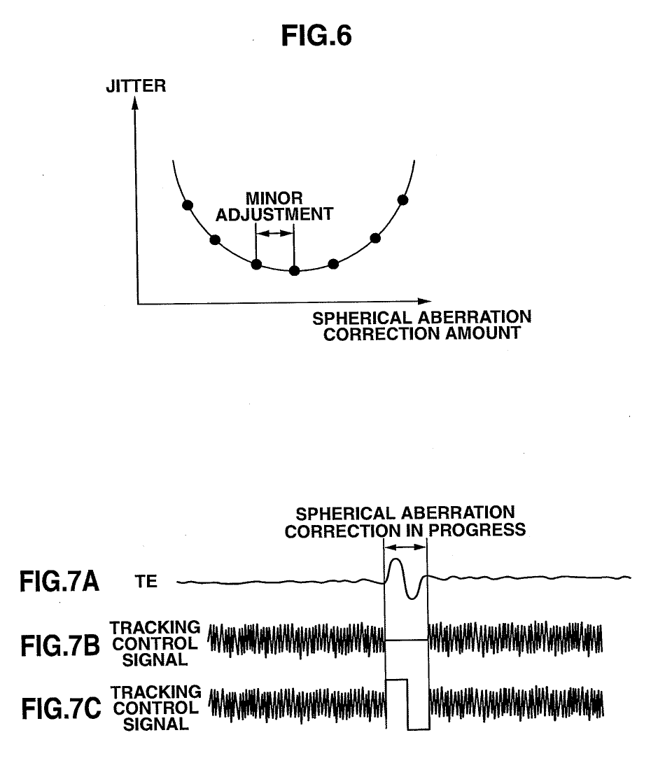

More specifically, when the distance between the concave lens 20 and the convex lens 21 in the spherical aberration corrector 9 is changed little by little (i.e., the spherical aberration correction amount is changed little by little) and the jitter in the reproduction signal is measured each time, the relationship between the spherical aberration correction amount and the jitter as shown in FIG. 6 can be obtained. The microprocessor 2 then selects the smallest jitter from jitters obtained in the jitter measurement performed the predetermined number of times and judges the spherical aberration correction amount corresponding to the smallest jitter as being the spherical aberration correction amount in which the jitter becomes smallest.

The microprocessor 2 moves the convex lens 21 in the spherical aberration corrector 9 to the corresponding position for obtaining the spherical aberration correction amount determined in step SP17 (SP18), and then completes the spherical aberration correction amount adjustment and returns to the adjustment processing (FIG. 4).

(1-3) Effect and Advantage of First Embodiment

In the optical disc device 1 having the configuration described above, during the spherical aberration correction amount adjustment, although the tracking error signal TE is disturbed as shown in section (A) in FIG. 7 when the convex lens 21 in the spherical aberration corrector 9 is moved, the digital signal processor 3 outputs the tracking control signal with a constant level according to the tracking error signal TE that has been held immediately before the movement of the convex lens 21 as shown in section (B) in FIG. 7, and the tracking control is performed based on this tracking control signal.

Accordingly, the off-track of the light beam L1, which results from the disturbance of the tracking error signal TE, can be efficiently prevented, and therefore the entire processing time for the spherical aberration correction amount adjustment can be shortened.

### (2) Second Embodiment

(2-1) Configuration of Optical Disc Device in Second Embodiment

The reference numeral 40 in FIG. 1 represents the entire optical disc device according to a second embodiment. The optical disc device 40 has the same configuration as the optical disc device 1 in the first embodiment except that: the scanning position of the light beam L1 on the optical disc 6 is moved to a track on which spherical aberration correction data has been recorded (i.e., track jump, etc.) when the convex lens 21 (FIG. 2) in the spherical aberration corrector 9 is moved during the spherical aberration correction amount adjustment described above regarding step SP6 in FIG. 4; and the configuration of a digital signal processor 41 is accordingly different.

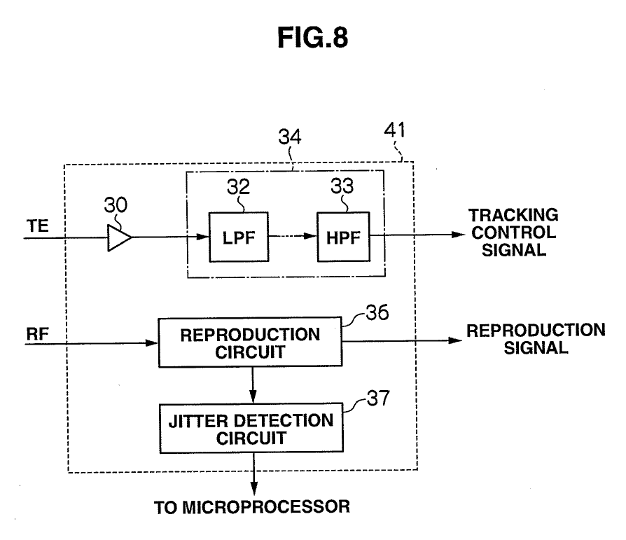

Specifically, in the optical disc device 40 shown in FIG. 8, in which like components are shown with like numerals from FIG. 3, the digital signal processor 41 has a configuration in which the switching circuit 31 (FIG. 3) and the hold circuit 35 (FIG. 3) are omitted from the digital signal processor 3 in the first embodiment.

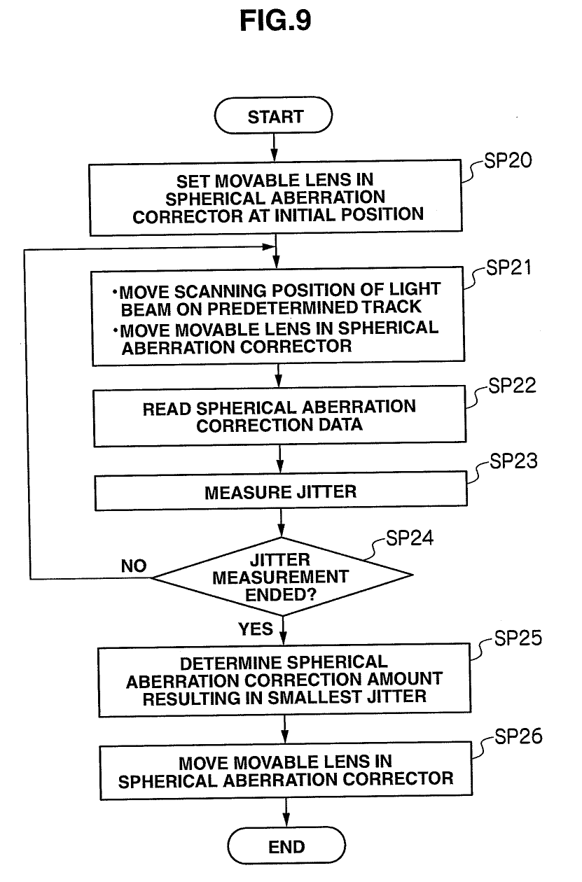

The microprocessor 42 performs the processing of SP6 in FIG. 4 (spherical aberration amount correction adjustment) based on a control program stored in an internal memory (not shown) and in accordance with the processing sequence of spherical aberration correction amount adjustment shown in FIG. 9.

Specifically, when the process proceeds to step SP9 in the adjustment processing, the microprocessor 42 starts the spherical aberration correction amount adjustment shown in FIG. 9. First, the microprocessor 42 controls, via the digital signal processor 41 and the driver 4, the spherical aberration correction motor 22 (FIG. 2) in the above-described spherical aberration corrector 9 to position the convex lens 21 at the initial position—the position closest to the concave lens 20 (SP20).

Next, the microprocessor 42 controls, via the digital signal processor 41 and the driver 4, the biaxial actuator 13 in the optical pickup 7 and, if needed, a seek mechanism that moves the optical pickup 7 in the radial direction of the optical disc 6 to move the scanning position of the light beam L1 on the optical disc 6 to a track on which the above spherical aberration correction data has been recorded (SP21).

At the same time, the microprocessor 42 drives, via the digital signal processor 41 and the driver 4, the spherical operation aberration correction motor 22 (FIG. 2) in the above-described spherical aberration corrector 9 provided in the optical pickup 7 by one pulse (SP21). Accordingly, the convex lens 21 (movable lens) in the spherical aberration corrector 9 is moved away from the concave lens 20 (fixed lens) by a predetermined distance in the optical axis direction of the light beam L1.

Next, the microprocessor 42 performs the processing of steps SP22 and SP23, like in steps SP14 and SP15 in the spherical aberration correction amount adjustment processing described with reference to FIG. 5 in the first embodiment, and then judges whether or not the jitter measurement has been performed a predetermined number of times (SP24). When the judgment result is negative in step SP24, the microprocessor 42 returns to step SP21 and repeats the same processing until a positive judgment result is obtained in step SP24 (from step SP21 to step SP24, and back to step SP21).

When the microprocessor 42 has performed the jitter measurement the predetermined number of times and a positive judgment result is obtained in step SP24, the microprocessor 42 determines the spherical aberration correction amount with the smallest jitter from jitters obtained by the jitter measurement as in steps SP17 and SP18 in the first embodiment (SP25). Then the microprocessor 42 moves the convex lens 21 in the spherical aberration corrector 9 to the corresponding position for obtaining the determined spherical aberration correction amount (SP26). Then the microprocessor 42 completes the spherical aberration correction amount adjustment and returns to the adjustment processing (FIG. 4).

(2-2) Effect and Advantage of Second Embodiment

In the optical disc device 40 having the above configuration, although the tracking error signal TE is disturbed as shown in section (A) in FIG. 7 when the convex lens 21 in the spherical aberration corrector 9 is moved during the spherical aberration correction amount adjustment, the scanning position of the light beam L1 on the optical disc 6 is moved to a track on which the spherical aberration correction data has been recorded as shown in section (C) in FIG. 7.

Accordingly, in the optical disc device 40, the tracking control can be prevented from being affected by the disturbance generated in the tracking error signal TE. In addition, since the scanning position of the light beam L1 on the optical disc 6 is moved to a track on which the spherical aberration correction data has been recorded while the convex lens 21 in the spherical aberration corrector 9 is being moved as described above, the entire processing time of the spherical aberration correction amount adjustment can further be shortened compared to the first embodiment described above with reference to FIG. 5.

### (3) Modification

Although this invention is employed in the optical disc devices 1 and 40 configured as shown in FIG. 1 in the first and second embodiments above, the present invention is not limited to this configuration. Specifically, this invention is widely applicable to optical disc devices having various other configurations as long as the optical disc devices are arranged so that, during the spherical aberration correction amount adjustment by the spherical aberration corrector 9, the tracking error signal TE is held in the state immediately before the spherical aberration correction amount is changed by the spherical aberration corrector 9 and the tracking control is performed based on the held tracking error signal TE while the spherical aberration correction amount is being changed by the spherical aberration corrector 9; or arranged so that the scanning position of the light beam L1 on the optical disc 6 is moved to the track on which the spherical aberration correction data has been recorded while the spherical aberration correction amount is being changed by the spherical aberration corrector 9.

Although the spherical aberration corrector 9 is configured as shown in FIG. 2 in the first and second embodiments above, this invention is not limited to this configuration. A wide variety of other configurations may be employed for the spherical aberration corrector 9, e.g., a configuration for correcting the spherical aberration using a liquid crystal element.

Although a tracking error signal generator that generates the tracking error signal with a signal level according to a off-track amount of the light beam L1 on the optical disc 6 based on the reflection light L2 of the light beam L1 includes the light receiver 11 in the optical pickup 7 and the arithmetic circuit 12 in the first and second embodiments above, this invention is not limited to this configuration. A wide variety of other configurations may be employed for the tracking error signal generator.

In addition, although a tracking controller for performing the tracking control based on the tracking error signal includes the microprocessors 2 and 42 and the digital signal processors 3 and 41 in the first and second embodiments above, this invention is not limited to this configuration. A wide variety of other configurations may be employed for the tracking controller.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An optical disc device that reads/writes data from/to an optical disc by projecting a light beam onto the optical disc, the optical disc device comprising:
a spherical aberration corrector that corrects spherical aberration of the light beam on the optical disc;
a tracking error signal generator that generates a tracking error signal with a signal level according to an off-track amount of the light beam on the optical disc based on a reflection light of the light beam reflected by the optical disc;
a tracking controller that performs tracking control based on the tracking error signal, wherein
during an adjustment for a spherical aberration correction amount performed by the spherical aberration corrector, the tracking controller holds the tracking error signal immediately before the spherical aberration corrector changes the spherical aberration correction amount and performs the tracking control based on the held tracking error signal while the spherical aberration corrector is changing the spherical aberration correction amount.

2. The optical disc device according to claim 1, wherein:
the spherical amount corrector includes at least two lenses disposed on the optical axis of the light beam and changes the spherical aberration correction amount by changing the distance between the two lenses; and
the tracking controller holds the tracking error signal immediately before the spherical aberration corrector changes the distance between the two lenses and performs the tracking control based on the held tracking error signal while the distance between the two lenses is being changed.

3. A control method for an optical disc device that reads/writes data from/to an optical disc by projecting a light beam onto the optical disc, the method comprising:
a first step of, when a spherical aberration correction amount for correcting spherical aberration of the light beam on the optical disc is adjusted by a spherical aberration corrector, holding a tracking error signal immediately before the spherical aberration correction amount is changed by the spherical aberration corrector; and
a second step of, while the spherical aberration correction amount is being changed by the spherical aberration corrector, performing a tracking control based on the held tracking error signal.

4. The control method according to claim 3, wherein:
the spherical aberration corrector includes at least two lenses disposed on the optical axis of the light beam and changes the spherical aberration correction amount by changing the distance between the two lenses;
the spherical aberration corrector holds the tracking error signal immediately before the distance between the two lenses is changed in the first step; and
the tracking control is performed based on the held tracking error signal while the distance between the two lenses is being changed.

5. An optical disc device that reads/writes data from/to an optical disc by projecting a light beam onto the optical disc, the device comprising:
a spherical aberration corrector that corrects spherical aberration of the light beam on the optical disc;
a tracking error signal generator that generates a tracking error signal with a signal level according to an off-track amount of the light beam on the optical disc based on a reflection light of the light beam reflected by the optical disc;
a tracking controller that performs tracking control based on the tracking error signal, wherein
during an adjustment for a spherical aberration correction amount performed by the spherical aberration corrector, the tracking controller moves a scanning position of the light beam on the optical disc to a predetermined track while the spherical aberration corrector is changing the spherical aberration correction amount.

6. The optical disc device according to claim 5, wherein:
the spherical aberration corrector includes at least two lenses disposed on the optical axis of the light beam and changes the spherical aberration correction amount by changing the distance between the two lenses; and
the tracking controller moves the scanning position of the light beam on the optical disc to the predetermined track while the spherical aberration corrector is changing the distance between the two lenses.

7. The optical disc device according to claim 6, wherein:
the spherical aberration corrector adjusts the spherical aberration correction amount by reproducing spherical aberration correction data recorded on a predetermined position in the optical disc while sequentially changing the distance between the two lenses, detecting the quality of reproduced spherical aberration correction data and determining the distance between the two lenses so that the quality becomes highest; and
the tracking controller moves the scanning position of the light beam on the optical disc to a track in which the spherical aberration correction data has been recorded while the distance between the two lenses is being changed.

8. A control method for an optical disc device that reads/writes data from/to an optical disc by projecting a light beam onto the optical disc, the method comprising:
moving, when a spherical aberration corrector that corrects spherical aberration for a light beam on the optical disc adjusts a spherical aberration correction amount, a scanning position of the light beam on the optical disc to a predetermined track while the spherical aberration corrector is changing the spherical aberration correction amount.

9. The method according to claim 8, wherein:
the spherical aberration corrector includes at least two lenses disposed on the optical axis of the light beam and changes the spherical aberration correction amount by changing the distance between the two lenses; and
the scanning position of the light beam on the optical disc is moved to the predetermined track while the spherical aberration corrector is changing the distance between the two lenses.

10. The method according to claim 9, wherein:
the spherical aberration corrector adjusts the spherical aberration correction amount by reproducing spherical aberration correction data recorded on a predetermined position in the optical disc while sequentially changing the distance between the two lenses, detecting the quality of reproduced spherical aberration correction data and determining the distance of the two lenses so that the quality becomes highest; and
the scanning position of the light beam on the optical disc is moved to a track on which the spherical aberration correction data is recorded while the distance between the two lenses is being changed.
